(19) United States
(12) Patent Application Publication
(10) Pub. No.: US 2010/0068066 A1
(43) Pub. Date: Mar. 18, 2010

(54) SYSTEM AND METHOD FOR GENERATING MODULATED PULSED FLOW

(75) Inventor: Ronald Scott Bunker, Niskayuna, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/209,239

(22) Filed: Sep. 12, 2008

(51) Int. Cl. F01D 5/08; F01D 5/18; F15C 1/06; F15C 1/22

(52) U.S. Cl. 416/97 R; 416/232; 137/826

(57) ABSTRACT

A device includes a fluid flow channel having a channel inlet for receiving a pressurized fluid for flow through the fluid flow channel and a channel outlet for discharging the pressurized fluid therefrom. A passive flow element is situated within the fluid flow channel or proximate to the channel inlet. The passive flow element includes an element inlet for receiving the pressurized fluid, and an element outlet. The passive flow element also includes a cavity for receiving the pressurized fluid from the element inlet and generating a periodic flow variation of the pressurized fluid so as to modulate the pressurized fluid flow rate through the element outlet.

### STATEMENT REGARDING FEDERALLY SPONSORED RESEARCH & DEVELOPMENT

This invention was made with Government support under contract number DE-FC26-05NT42643 awarded by U.S. Department of Energy. The Government has certain rights in the invention.

### BACKGROUND

The invention relates generally to modulating fluid flow and more particularly to systems and methods for passively generating modulated pulsed fluid flow in devices requiring modulated fluid flow.

In one conventional system, a gas turbine engine includes a compressor provided for pressurizing ambient air. The pressurized air is then mixed with a fuel in a combustor and combusted for generating combustion gases. The combustion gases are expanded through a turbine to extract energy therefrom. The turbine includes a plurality of stator vanes, which channel the combustion gases through a plurality of rotor blades, which in turn rotate a rotor disk for providing power. Since the combustion gases are hot, the stator vanes and the rotor blades are typically internally cooled using a portion of the compressed air bled from the compressor.

The stator vanes and rotor blades may include a hollow airfoil having an internal cooling flow channel. The cooling air bled from the compressor is channeled through the internal flow channels of the vanes and blades for internally cooling the airfoils. Convective heat transfer cooling may be enhanced by providing turbulators within the airfoil. The cooling air may simply be channeled through the airfoils, or the airfoils may include trailing edge apertures or film cooling holes along either the pressure or suction sides of the airfoil or both. These outlets discharge the cooling air from the airfoil directly into the combustion gases and are suitably sized to provide a minimum backflow pressure margin to prevent the combustion gases from flowing into the airfoils through these outlets.

In one conventional technique, an actuating valve is used to provide pulsed or intermittent flow for convection cooling of airfoils. This technique demonstrates that convective heat transfer coefficients may be increased using pulsed flow instead of continuous airflow. However, the conventional systems used to generate pulsating airflow are not located on-board the airfoils. In other words, the systems are located spaced apart from the airfoils. This results in dampening of the modulating pressure signal in the airflow.

It would be useful to have a system and method for passively generating modulated pulsed flow in devices requiring modulated fluid flow.

### BRIEF DESCRIPTION

In accordance with one embodiment of the present invention, a device includes a fluid flow channel having a channel inlet for receiving a pressurized fluid for flow through the fluid flow channel and a channel outlet for discharging the pressurized fluid therefrom. A passive flow element is situated within the fluid flow channel. The passive flow element includes an element inlet for receiving the pressurized fluid, and an element outlet. The passive flow element also includes a cavity for receiving the pressurized fluid from the element inlet and generating a periodic flow variation of the pressurized fluid so as to modulate the pressurized fluid flow rate through the element outlet.

In accordance with another exemplary embodiment, a rotary machine is disclosed.

In accordance with another exemplary embodiment, a turbine is disclosed.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a rotary machine, such as a turbine assembly;

FIG. 2 is a diagrammatical representation of an airfoil having a passive flow element incorporated therein in accordance with an exemplary embodiment of the present invention;

FIG. 3 is a diagrammatical representation of a passive flow element in accordance with an exemplary embodiment of the present invention;

FIG. 4 is a diagrammatical representation of another passive flow element in accordance with an exemplary embodiment of the present invention;

FIG. 5 is a diagrammatical representation of another passive flow element in accordance with an exemplary embodiment of the present invention;

FIG. 6 is a partial three dimensional representation of another passive flow element in accordance with an exemplary embodiment of the present invention;

FIG. 7 is a diagrammatical representation of another airfoil having a passive flow element incorporated therein in accordance with an exemplary embodiment of the present invention; and

FIG. 8 is a diagrammatical representation of an airfoil having a plurality of passive flow elements incorporated therein in accordance with an exemplary embodiment of the present invention.

### DETAILED DESCRIPTION

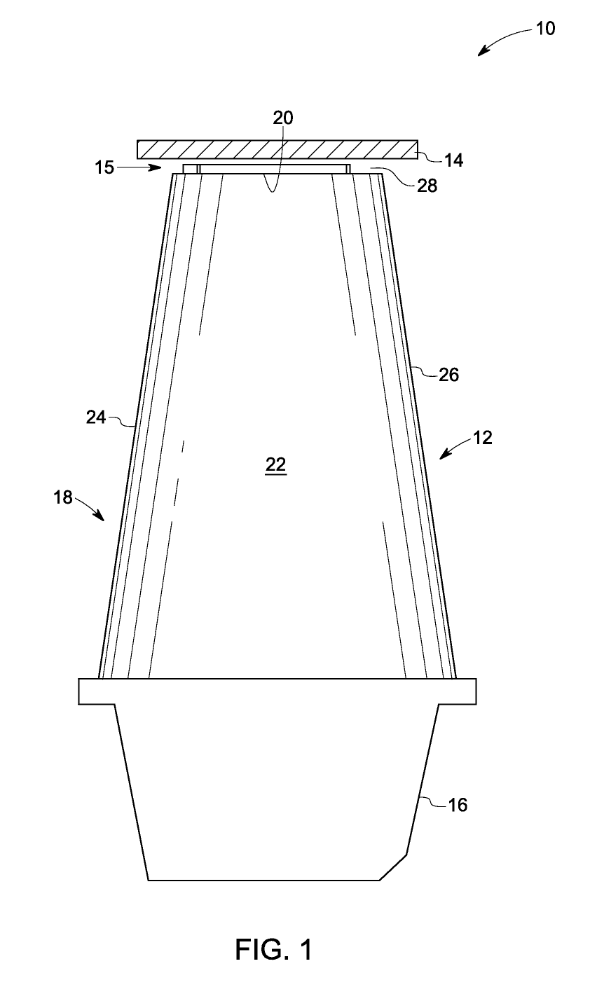

As discussed in detail below, embodiments of the present invention provide a device including a fluid flow channel having a channel inlet for receiving a pressurized fluid for flow through the channel and channel outlets for discharging the pressurized fluid. At least one passive flow element is situated within the fluid flow channel. The passive flow element includes an element inlet, an element outlet, and a cavity. The cavity is configured for receiving the pressurized fluid from the element inlet and generating a periodic flow variation of the pressurized fluid so as to modulate the pressurized fluid flow rate through the element outlet. In one embodiment, the device includes a rotary machine. In another embodiment, the rotary machine includes a turbine. In some embodiments, fluid may include liquid, gas, or combinations thereof. Gas may include, for example, air, steam, nitrogen, or combinations thereof. In yet another embodiment, passive modulated pulsed flow of a gas stream enables reduction in gas usage. Complex active control systems for modulating the flow of gas may be avoided. As used herein, singular forms such as “a,” “an,” and “the” include plural referents unless the context clearly dictates otherwise. Specific embodiments of the present invention are discussed below referring generally to FIGS. 1-8.

Referring to FIG. 1, an exemplary rotary machine, such as a turbine assembly 10, is illustrated. The turbine assembly 10 includes a plurality of rotary members or rotors 12 and a stationary member 14, such as a stationary outer casing, concentrically disposed about the rotary members 12. The turbine assembly 10 may include a sealing system 15 between the rotary and stationary members 12 and 14. Each rotary member 12 includes an inner base portion 16, a hollow airfoil or rotor blade 18, and an outer tip portion 20.

The airfoil 18 extends outwardly into a working fluid flow path of the turbine assembly 10 where the working medium gases exert motive forces on a plurality of surfaces thereof. The airfoil 18 includes an upstream sidewall 22 and an opposite downstream side wall (not shown) joined together at a leading edge 24 and a trailing edge 26. The stationary member 14 is spaced apart from the tip portion 20 so as to define a clearance gap 28 therebetween. The performance and efficiency of the turbine assembly 10 is affected by the clearance gap 28. As the amount of leakage flow through the clearance gap increases, the efficiency of the turbine is reduced because the leakage flow does not exert motive forces on the airfoil surfaces and accordingly does not provide work. The sealing system 15 is configured to reduce leakage of fluid between the rotary and stationary members 12 and 14.

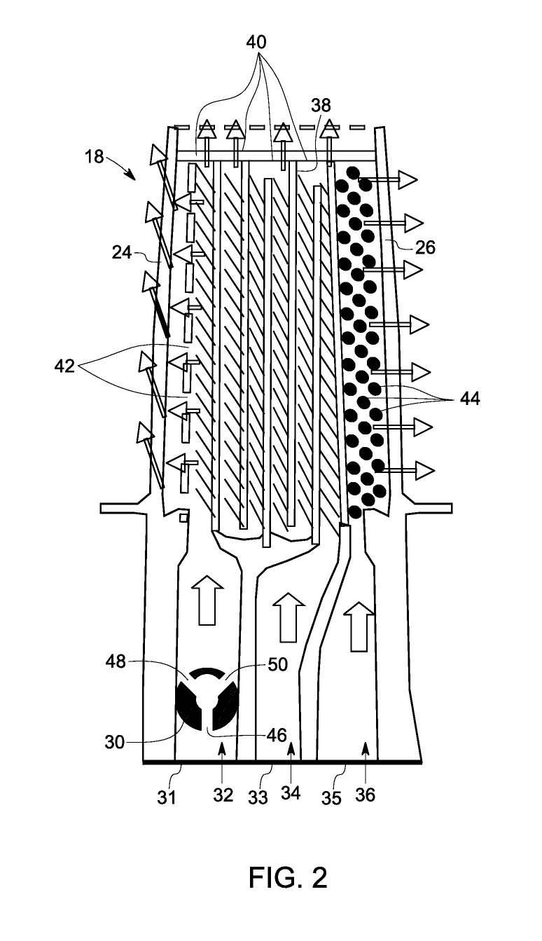

In the illustrated embodiment, the combustion gases are channeled through the plurality of airfoils 18, which in turn rotate a rotor disk for providing power. Since the combustion gases are hot, the airfoils 18 are typically internally cooled using a portion of the compressed air bled from a compressor. Each airfoil 18 is provided with at least one passive flow element 30 (illustrated in FIG. 2) configured to provide a passive modulated pulsed airflow in the airfoil. The passive flow element is explained in greater detail with reference to subsequent figures. In some embodiments, a passive flow element may be used for other components in the rotary machine requiring modulated fluid flow. Although the aspects of the present invention are described herein with respect to turbine assembly 10, in certain other exemplary embodiments the passive flow elements may be also used in other rotary machines in which modulation of fluid is a concern. For example, exemplary rotary machines may include compressors, pumps, motors, or the like. Moreover, exemplary systems utilizing these rotary machines may include, for example, power generation systems, industrial machines, watercraft, aircraft, and other vehicles. In the illustrated embodiment, the turbine assembly 10 may further include a steam turbine or a gas turbine. Moreover, the turbine assembly 10 may include a compressor coupled to a turbine via a shaft, one or more gas turbine combustors disposed between the compressor and the turbine, or a fuel injection system coupled to the one or more gas turbine combustors. In certain other embodiments, the passive flow elements may be used in applications other than rotary machines requiring modulated fluid flow.

Referring now to FIG. 2, an exemplary airfoil 18 is illustrated. The airfoil 18 includes three independent internal flow channels, i.e. a first channel 32, a second channel 34, and a third channel 36. The first, second, and third channels 32, 34, and 36 include channel inlets 31, 33, 35 respectively for receiving pressurized cooling air from the compressor. The airfoil 18 may either be smooth inside or may include conventional turbulators 38 or other heat transfer enhancement techniques as desired for further enhancing convective heat transfer. The airfoil 18 also includes a plurality of channel outlets 40 for discharging the pressurized air from the airfoil 18. In the illustrated embodiment, a portion of the cooling air fed through the channel inlet 31 is also discharged through the leading edge 24 of the airfoil 18 via a plurality of cross-over impingement holes 42 of the first channel 32. Also, a portion of the cooling air fed through the channel inlet 36 is discharged through the trailing edge 26 of the airfoil 18 via gaps in a pin bank 44 disposed in the third channel 36. It should be noted herein the configuration of the airfoil 18 might vary depending upon the application.

In the illustrated embodiment, the passive flow element 30 is situated within the first channel 32. Even though the passive flow element 30 is shown disposed to the upstream side of the first channel 32, the element 30 may be disposed anywhere in the first channel 32 depending upon the application. In another embodiment, a plurality of passive flow elements 30 may be disposed in the first channel 32. In certain other embodiments, one or more passive flow elements 30 may also be disposed in one or more predefined locations of the second, and third channels 34, 36. The passive flow elements 30 may be provided in the channels 32, 34, and 36 by casting, machining, brazing, or combinations thereof.

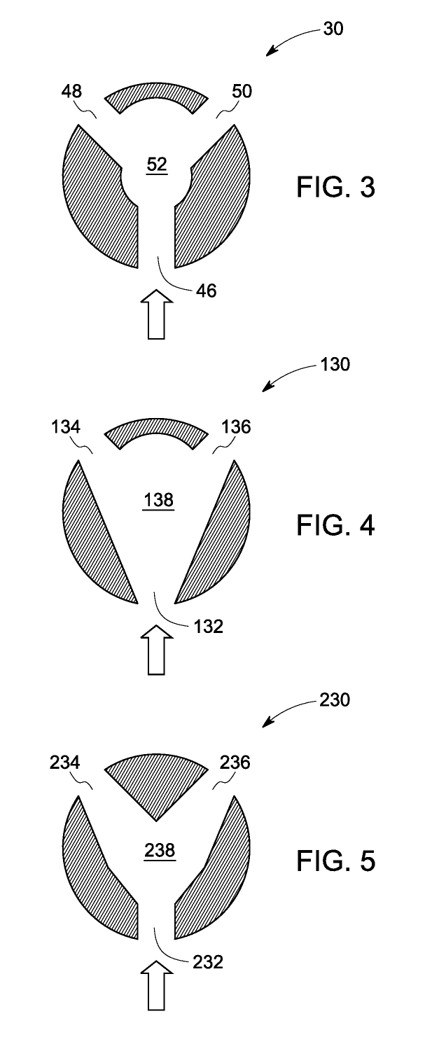

The illustrated passive flow element 30 includes an element inlet 46 for receiving pressurized cooling air and two element outlets 48, 50 for discharging pressurized cooling air from the element 30. In another embodiment, the element 30 may include only one element outlet. In yet another embodiment, the element 30 may include more than two outlets. The element 30 also includes a cavity 52 (illustrated in FIG. 3) for receiving pressurized cooling air from the element inlet 46 and generating a “periodic flow variation” of the pressurized cooling air so as to modulate pressurized air flow rate through the element outlets 48, 50. In other words, the element 30 serves to generate a passive modulated pulsed cooling airflow in the first channel 32. It should be noted herein that in other embodiments, the design of the passive element 30 might vary depending upon the application.

In the embodiment described herein, the passive flow element 30 has no moving parts and is effective for pulsing and alternating the cooling air between the two respective outlets 48, 50 for improving cooling of the respective airfoils with reduced amounts of cooling air. The passive flow element may be suitably sized for channeling the required air flow rates of the cooling air at a particular pulsation frequency through the airfoil 18.

The element 30 may be used for an entire blade, or for an individual channel in a blade, or even a portion of an individual channel. The passive flow elements 30 also may be applied to various parts, besides rotor blades, which require cooling. For example, stator vanes, stator casings, shrouds, and shroud supports (not shown) may be configured with passive flow elements for providing cooling thereof. In some other embodiments, the passive flow element 30 may be used for other applications where modulation of pressurized gas flow rate is a concern.

Referring to FIG. 3, an exemplary passive flow element 30 is illustrated. The illustrated passive flow element 30 has an aero-geometry i.e. has a predefined pressure loss coefficient. Other geometries of the element 30 are also envisaged. The geometry may be axi-symmetric or non axi-symmetric. The passive flow element 30 includes the element inlet 46 for receiving pressurized cooling air and two element outlets 48, 50 for discharging pressurized cooling air from the element 30.

The element 30 also includes the cavity 52 for receiving pressurized cooling air from the element inlet 46 and generating a periodic flow variation of the pressurized cooling air so as to modulate pressurized airflow rate through the element outlets 48, 50. In one embodiment, the cavity 52 includes a resonant cavity that exhibits a resonant frequency. The cavity 52 is typically symmetrical or axi-symmetric about a centerline and forces the incoming flow to circulate unsteadily inside the cavity space. As the flow establishes in one portion, the excess volume and flow resistance allows a buildup of pressure in the non-flowing portion, which then drives the flow to change due to the pressure field resulting in oscillation at a certain frequency depending on the cavity geometry, fluid properties, fluid pressure, fluid temperature, and the number, size, and location of element inlets and outlets thereby modulating the cooling air flow rate through the two element outlets 48, 50. In one embodiment, the “resonant cavity” creates an oscillatory flow motion alternating flow between the two element outlets 48, 50. The flow is switched between the element outlets 48, 50 back and forth at a particular pulsation frequency, and an oscillating pressure magnitude. In one example, the pressurized cooling airflow rate may have a pulsation frequency in the range from 1 to 100 Hertz. In another embodiment, the pressurized cooling airflow rate may have a pulsation frequency in the range from 5 to 50 Hertz.

Referring to FIG. 4, another exemplary passive flow element 130 is illustrated. The geometry may be axi-symmetric or non axi-symmetric. The passive flow element 130 includes an element inlet 132 for receiving pressurized cooling air and two element outlets 134, 136 for discharging pressurized cooling air from the element 130. A cavity 138 of the element has a different geometry compared to the embodiment illustrated in FIG. 3. The geometry of the cavity 138 may be varied to generate a desired modulated cooling airflow rate. The element 130 passively pulsates the cooling airflow by creating a larger periodic pressure drop with a particular pulsation frequency. Pulsed flow facilitates reduced coolant usage compared to providing continuous cooling airflow. It should be noted herein that in the embodiments disclosed herein, the elements 130 are disposed “on-board” the airfoils. Hence damping of pressure oscillations of the airflow is avoided compared to systems disposed spaced apart from the airfoils.

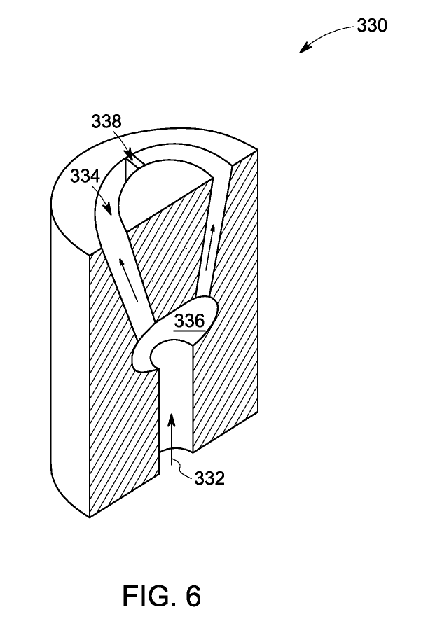

Referring to FIG. 5, another exemplary passive flow element 230 is illustrated. The passive flow element 230 includes an element inlet 232 for receiving pressurized cooling air and two element outlets 234, 236 for discharging pressurized cooling air from the element 230. The cavity 238 of the element has a different geometry compared to the embodiments illustrated in FIGS. 3 and 4. The cavity 238 is smaller compared to cavities 52 and 138. The element 230 passively pulsates the cooling airflow by creating a larger periodic pressure drop with a particular pulsation frequency. It should be noted herein that embodiments illustrated in FIGS. 3-5 are examples. The geometry and dimensions of the passive flow elements may vary depending on the application.

Referring to FIG. 6, another exemplary passive flow element 330 is illustrated. The passive flow element 330 includes an element inlet 332 for receiving pressurized cooling air and a single element outlet 334 for discharging pressurized cooling air from the element 330. The element 330 also includes the cavity 336 for receiving pressurized cooling air from the element inlet 332 and generating a periodic flow variation of the pressurized cooling air so as to modulate pressurized airflow rate through the element outlet 334. In the illustrated embodiment, sweeping a feature in a 360-degree manner forms the element outlet 334. One or more structural connectors 338 may be provided to the element outlet 334.

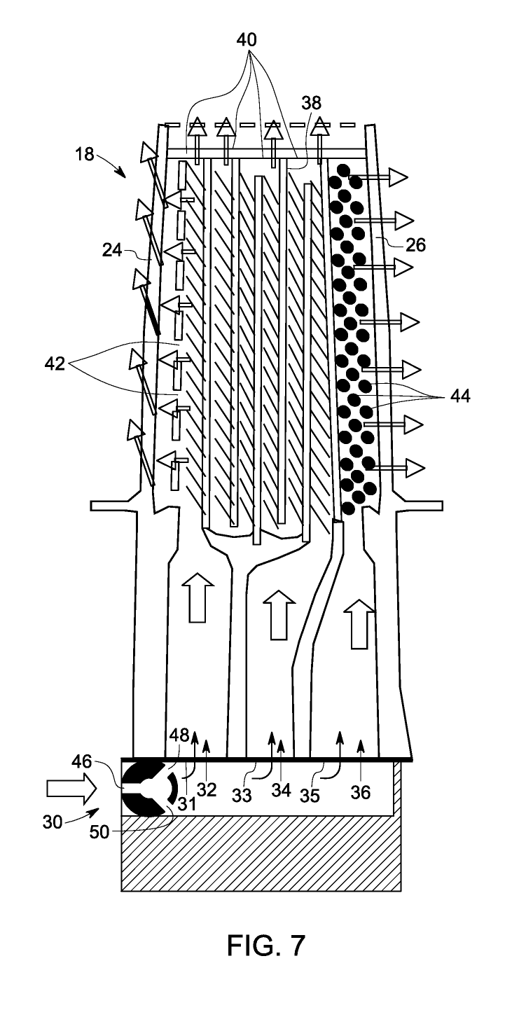

Referring now to FIG. 7, another exemplary airfoil 18 is illustrated. The airfoil 18 includes three independent internal flow channels, which are shown as the first channel 32, the second channel 34, and the third channel 36. The first, second, and third channels 32, 34, and 36 include channel inlets 31, 33, 35 respectively for receiving pressurized cooling air from the compressor. It should be noted herein although the geometry of the airfoil 18 is the similar to the configuration illustrated in FIG. 2; the geometry might vary in other embodiments depending on the application.

In the illustrated embodiment, the passive flow element 30 is situated proximate to the channel inlet 31 of the first channel 32. In some embodiments, more than one passive flow elements is situated proximate to the channel inlet 31 of the channel 32. In the illustrated embodiment, the element 30 passively pulsates the cooling airflow by creating a larger periodic pressure drop with a particular pulsation frequency. The modulated pulsed airflow from the element 30 is then directed through the channel inlets 31, 33, and 35 into the channels 32, 34, and 36. In other words, the element 30 is positioned in such a way so as to modulate fluid flow to the entire airfoil 18.

In another embodiment, the element 30 may also be provided proximate to the channel inlet 33 of the second channel 34. In some embodiments, more than one passive flow element 30 is situated proximate to the channel inlet 33 of the channel 34. In yet another embodiment, the element 30 may also be provided proximate to the channel inlet 35 of the third channel 36. In some embodiments, more than one passive flow element 30 is situated proximate to the channel inlet 35 of the channel 36. In certain embodiments, one or more elements may be disposed proximate to each of the channel inlets 31, 33, and 35. All such permutations and combinations of disposing elements 30 are envisaged.

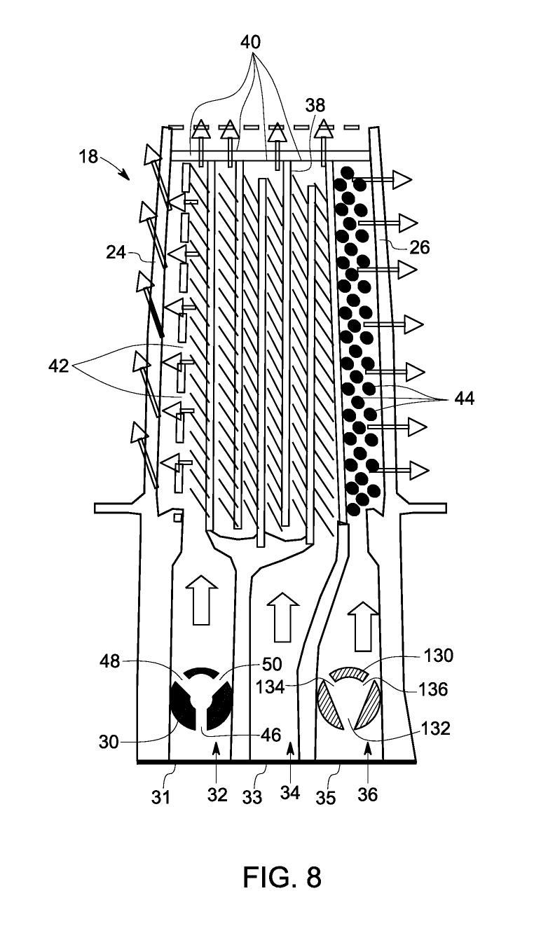

Referring now to FIG. 8, an exemplary airfoil 18 is illustrated. The configuration of the airfoil 18 is similar to the embodiment illustrated in FIG. 2. In the illustrated embodiment, the passive flow element 30 is situated within the first channel 32. Additionally, another passive flow element 130 is situated within the third channel 36. Even though the passive flow element 130 is shown disposed to the upstream side of the third channel 36, the element 130 may be disposed anywhere in the third channel 36 depending upon the application. In another embodiment, a plurality of passive flow elements may be disposed in the third channel 36. All permutations and combinations of embodiments illustrated in FIGS. 2-7 are envisaged.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A device comprising:
a fluid flow channel comprising a channel inlet for receiving a pressurized fluid for flow through the fluid flow channel and a channel outlet for discharging the pressurized fluid therefrom; and
a passive flow element situated within the fluid flow channel or proximate to the channel inlet, the passive flow element comprising
an element inlet for receiving the pressurized fluid,
an element outlet, and
a cavity for receiving the pressurized fluid from the element inlet and generating a periodic flow variation of the pressurized fluid so as to modulate the pressurized fluid flow rate through the element outlet.

2. The device of claim 1, wherein the pressurized fluid comprises a gaseous coolant.

3. The device of claim 1, further comprising a plurality of passive flow elements situated within one or more fluid flow channels.

4. The device of claim 1, wherein the pressurized fluid flow rate has a pulsation frequency in the range from 1 to 100 hertz.

5. The device of claim 4, wherein the pressurized fluid flow rate has a pulsation frequency set based on a plurality of parameters comprising cavity geometry, fluid properties, fluid pressure, fluid temperature, and the number, size and location of element inlets and outlets, or combinations thereof.

6. A rotary machine comprising:
at least one hollow component comprising an internal fluid flow channel comprising a channel inlet for receiving a pressurized fluid for flow through the fluid flow channel, and a channel outlet for discharging the pressurized fluid therefrom; and
a passive flow element situated within the fluid flow channel or proximate to the channel inlet; the passive flow element comprising:
an element inlet for receiving the pressurized fluid;
an element outlet; and
a resonant cavity for receiving the pressurized fluid from the element inlet and generating periodic flow variation of the pressurized fluid so as to modulate the pressurized fluid flow rate through the element outlet.

7. The rotary machine of claim 6, wherein the pressurized fluid comprises cooling air.

8. The rotary machine of claim 6, wherein the cavity comprises an acoustically resonant cavity.

9. The rotary machine of claim 6, wherein the pressurized fluid flow rate has a pulsation frequency in the range from 1 to 100 hertz.

10. The rotary machine of claim 9, wherein the pressurized fluid flow rate has a pulsation frequency set based on a plurality of parameters comprising cavity geometry, fluid properties, fluid pressure, fluid temperature, and the number, size and location of element inlets and outlets, or combinations thereof.

11. A turbine comprising:
a hollow airfoil comprising an internal coolant flow channel comprising a channel inlet for receiving cooling fluid for flow through the coolant flow channel and a channel outlet for discharging the pressurized cooling fluid therefrom; and
a passive flow element situated within the internal coolant flow channel; the passive flow element comprising:
an element inlet for receiving the cooling fluid;
an element outlet; and
a cavity configured for receiving the cooling fluid from the element inlet and generating periodic flow variation of the cooling fluid so as to modulate the pressurized cooling fluid flow rate through the element outlet.

12. The turbine of claim 11, wherein the cavity comprises an acoustically resonant cavity.

13. The turbine of claim 11, wherein the pressurized cooling fluid flow rate has a pulsation frequency may be in the range from 1 to 100 hertz.

14. The turbine of claim 11, wherein the pressurized cooling fluid flow rate has a pulsation frequency set based on a plurality of parameters comprising cavity geometry, fluid properties, fluid pressure, fluid temperature, and the number, size, and location of element inlets and outlets, or combinations thereof.

15. A method comprising:
feeding a pressurized fluid through a channel inlet of a fluid flow channel to a passive flow element situated within the fluid flow channel;
providing modulated pressurized fluid flow rate into the fluid flow channel via the passive flow element;
wherein providing modulated pressurized fluid flow rate comprises;
guiding pressurized fluid through an element inlet to a cavity of the passive flow element;
generating periodic flow variation of the pressurized fluid in the cavity; and
modulating the pressurized fluid flow rate through an element outlet of the passive flow element.

16. The method of claim 16, further comprising setting pulsation frequency of the pressurized fluid flow rate based on a plurality of parameters comprising cavity geometry, fluid properties, fluid pressure, fluid temperature, and the number, size and location of element inlets and outlets, or combinations thereof.
